(19) United States
(12) Patent Application Publication
(10) Pub. No.: US 2018/0070398 A1
(43) Pub. Date: Mar. 8, 2018

(54) WIRELESS COMMUNICATION DEVICE AND COMMUNICATION CONTROL METHOD

(71) Applicant: FUJITSU LIMITED, Kawasaki-shi (JP)

(72) Inventor: Daisuke SAKAI, Sendai (JP)

(73) Assignee: FUJITSU LIMITED, Kawasaki-shi (JP)

(21) Appl. No.: 15/676,901

(22) Filed: Aug. 14, 2017

(30) Foreign Application Priority Data
Sep. 2, 2016 (JP) 2016-172217

(51) Int. Cl. H04W 76/02; H04W 72/04; H04W 92/18

(52) U.S. Cl. CPC H04W 76/023; H04W 88/06; H04W 92/18; H04W 72/0406

(57) ABSTRACT

A wireless communication device includes a receiver that receives permission information indicating a period, in which device-to-device communication that does not traverse a base station is permitted, the period being one of non-communication periods imposed by cellular communication that traverses the base station, a determination unit that determines whether the period, in which the device-to-device communication is permitted, has started based on the permission information received by the receiver, and a device-to-device communication unit that performs the device-to-device communication when the determination unit determines that the period, in which the device-to-device communication is permitted, has started.

### CROSS-REFERENCE TO RELATED APPLICATION

This application is based upon and claims the benefit of priority of the prior Japanese Patent Application No. 2016-172217, filed on Sep. 2, 2016, the entire contents of which are incorporated herein by reference.

### FIELD

The embodiment discussed herein is related to a wireless communication device and a communication control method.

### BACKGROUND

The 3rd Generation Partnership Project (3GPP), which is a telecommunications standard development organization, is studying Device to Device (D2D) communication in recent years. The D2D communication is terminal-to-terminal communication, in which a wireless terminal device communicates with another wireless terminal device without traversing a base station, and is expected to be useful as an emergency communication measure in, for instance, disaster or a like situation.

Some type of D2D communication employs a network assisted scheme. In such network-assisted D2D communication, a wireless terminal device acquires information about resources to be used in the D2D communication from a base station. Specifically, the wireless terminal device performs the D2D communication through assistance of a cellular communication network. More specifically, the wireless terminal device acquires information, e.g., information about a communication mode and a frequency band to be used in the D2D communication and information about transmission power and security, from the base station. The wireless terminal device directly communicates wirelessly with another wireless terminal device using the information acquired from the base station.

[Patent Document 1] Japanese Laid-open Patent Publication No. 2015-19178

[Patent Document 2] Japanese Laid-open Patent Publication No. 2013-223192

However, when a frequency band used in D2D communication and that used in cellular communication are identical, interference can disadvantageously occur between the D2D communication and the cellular communication. Specifically, when a frequency band designated to be used in D2D communication is identical to a frequency band used in cellular communication that traverses a base station, interference will occur between a wireless terminal device performing the D2D communication and another wireless terminal device performing the cellular communication.

To avoid such interference, the base station can be configured to control a communication mode or the transmission power of the D2D communication delicately. However, performing such control will undesirably increase complexity of processing to be performed by the base station and increase cost.

### SUMMARY

According to an aspect of an embodiment, a wireless communication device includes a receiver that receives permission information indicating a period, in which device-to-device communication that does not traverse a base station is permitted, the period being one of non-communication periods imposed by cellular communication that traverses the base station, a determination unit that determines whether the period, in which the device-to-device communication is permitted, has started based on the permission information received by the receiver, and a device-to-device communication unit that performs the device-to-device communication when the determination unit determines that the period, in which the device-to-device communication is permitted, has started.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a diagram illustrating a configuration of a wireless communication system according to an embodiment;

FIG. 2 is a block diagram illustrating a configuration of a base station according to the embodiment;

FIG. 3 is a diagram illustrating specific examples of subframe allocation;

FIG. 4 is a diagram illustrating a specific example of a frame structure;

FIG. 5 is a block diagram illustrating a configuration of a wireless terminal device according to the embodiment;

FIG. 6 is a sequence diagram illustrating a wireless communication method according to the embodiment; and

FIG. 7 is a flowchart illustrating a communication control method according to the embodiment.

### DESCRIPTION OF EMBODIMENT

Preferred embodiments of the present invention will be explained with reference to accompanying drawings. The disclosed technology is not limited to the embodiments explained below.

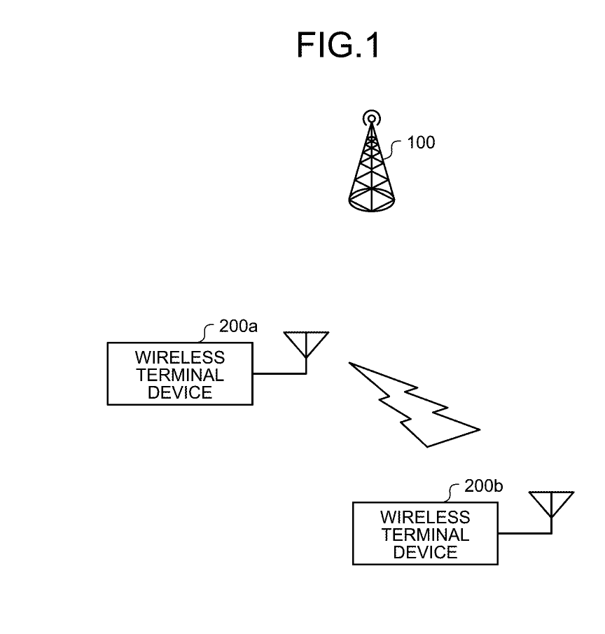

FIG. 1 is a diagram illustrating a configuration of a wireless communication system according to the embodiment. The wireless communication system illustrated in FIG. 1 includes a base station 100 and wireless terminal devices 200a and 200b. The base station 100 and the wireless terminal devices 200a and 200b are each a wireless communication device that performs wireless communication. Although two wireless terminal devices denoted by 200a and 200b are illustrated in FIG. 1, alternatively, three or more wireless terminal devices may be within a range communicable with the base station 100. Hereinafter, except for situations where the wireless terminal devices 200a and 200b are particularly distinguished, a wireless terminal device or wireless terminal devices that communicates or communicate with the base station 100 is or are referred to as the wireless terminal device 200 or the wireless terminal devices 200.

The base station 100 performs cellular communication with the wireless terminal device 200. Specifically, the base station 100 transmits and receives signals to and from the wireless terminal device 200 in accordance with a network's specified wireless communication scheme. More specifically, for instance, in a wireless communication system that employs Time Division Duplex (TDD) where uplink and downlink are time division duplexed, the base station 100 receives signals in time slots allocated to uplink and transmits signals in time slots allocated to downlink.

Additionally, the base station 100 accepts a D2D communication request from the wireless terminal device 200 and sends information about a communication mode, e.g., a frequency band to be used in the D2D communication, and information about transmission power and security to the wireless terminal device 200. At this time, the base station 100 determines, among GPs, each being a non-communication period when no uplink or downlink transmission occurs in cellular communication, a guard period (GP) to be allocated to the requested D2D communication and transmits permission information that permits performing D2D communication in the determined GP.

The wireless terminal device 200a, 200b performs cellular communication with the base station 100; the wireless terminal devices 200a and 200b perform D2D communication with each other without traversing the base station 100. When performing the D2D communication, the wireless terminal device 200 transmits a D2D request requesting to start D2D communication to the base station 100. In response to the D2D request, the wireless terminal device 200 performs D2D communication in the communication mode and using the transmission power designated by the base station 100. At this time, the wireless terminal device 200 receives permission information from the base station 100 and controls timing of the D2D communication so that the D2D communication is performed in the GP, in which the D2D communication is permitted.

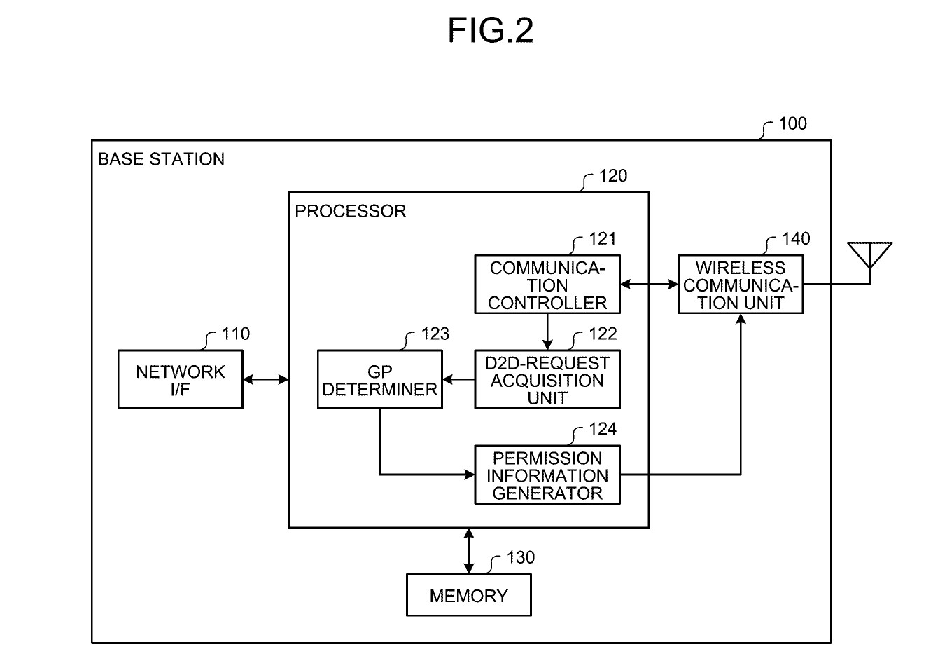

FIG. 2 is a block diagram illustrating a configuration of the base station 100 according to the embodiment. The base station 100 illustrated in FIG. 2 includes a network interface (hereinafter, abbreviated as “network I/F”) 110, a processor 120, a memory 130, and a wireless communication unit 140.

The network I/F 110, which is wire-connected to a not-illustrated master station, transmits and receives signals over a network. The network, to which the network I/F 110 is connected, includes a cellular communication system and may further include, for instance, an Internet server.

The processor 120, which may include, for instance, a Central Processing Unit (CPU), a Field Programmable Gate Array (FPGA), or a Digital Signal Processor (DSP), centrally controls the entire base station 100. More specifically, the processor 120 includes a communication controller 121, a D2D-request acquisition unit 122, a GP determiner 123, and a permission information generator 124.

The communication controller 121 controls cellular communication between the base station 100 and the wireless terminal device 200. More specifically, the communication controller 121 generates a transmission signal by encoding and modulating transmission data destined for the wireless terminal device 200 and outputs the transmission signal to the wireless communication unit 140. Additionally, the communication controller 121 obtains received data by demodulating and decoding a received signal received by the wireless communication unit 140. The received data includes, for instance, a request for starting D2D communication or a notification of completion of D2D communication transmitted from the wireless terminal device 200.

The D2D-request acquisition unit 122 acquires the D2D request transmitted from the wireless terminal device 200. The D2D-request acquisition unit 122 acquires the D2D request from received data received by cellular communication; this is because, when requesting to start D2D communication, the wireless terminal device 200 transmits the D2D request by cellular communication.

When the D2D request has been acquired by the D2D-request acquisition unit 122, the GP determiner 123 determines a guard period (GP) to be allocated to D2D communication to be performed by the wireless terminal device 200, which is the sender of the D2D request. More specifically, the GP determiner 123 determines a GP, in which the wireless terminal device 200 is permitted to perform the D2D communication, among GPs, each being a non-communication period when no uplink or downlink cellular wireless transmission occurs.

The GPs of cellular communication that uses TDD are described below. In cellular communication using TDD, uplink and downlink are time division duplicated. More specifically, for instance, a plurality of subframes is provided in a frame, which is a predetermined unit of time; each subframe is allocated to uplink or downlink.

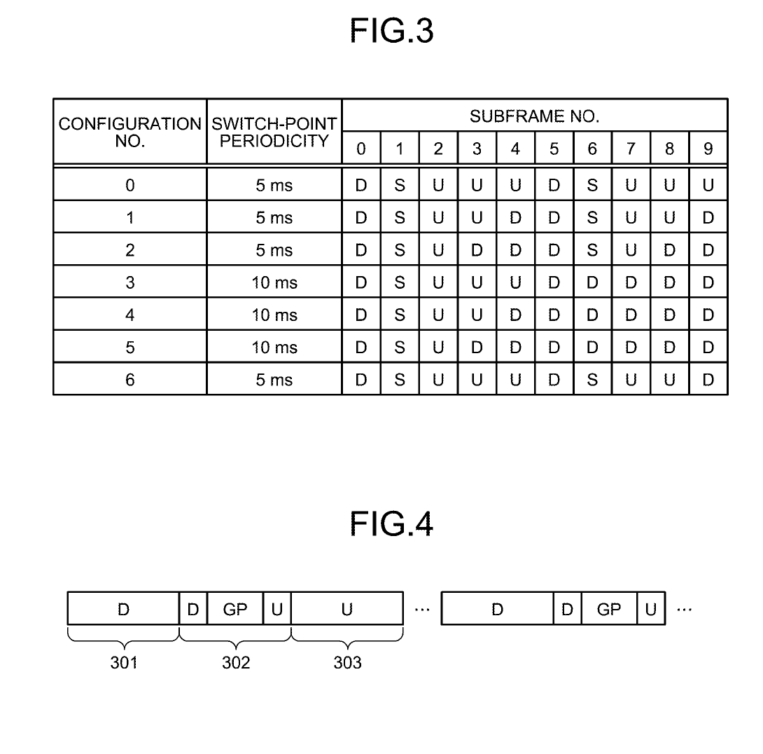

FIG. 3 is a diagram illustrating specific examples of subframe allocation within a frame. FIG. 3 illustrates an example, in which 10 1-millisecond (ms) subframes are provided in each of 10-ms frames; either downlink denoted by “D” or uplink denoted by “U” is allocated to each of the subframes. The subframes denoted by “S” in FIG. 3 are special subframes, each being a subframe to which downlink and uplink are partially allocated and which has a guard period between the uplink and the downlink. More specifically, the special subframe is a boundary subframe where switching from downlink to uplink occurs. Seven allocation examples, to which configuration numbers 0 to 6 are assigned, are illustrated in FIG. 3. The special subframe is allocated with periodicity of 5 ms or 10 ms in any one of the allocation examples. Put another way, downlink-to-uplink switch-point periodicity is 5 ms or 10 ms.

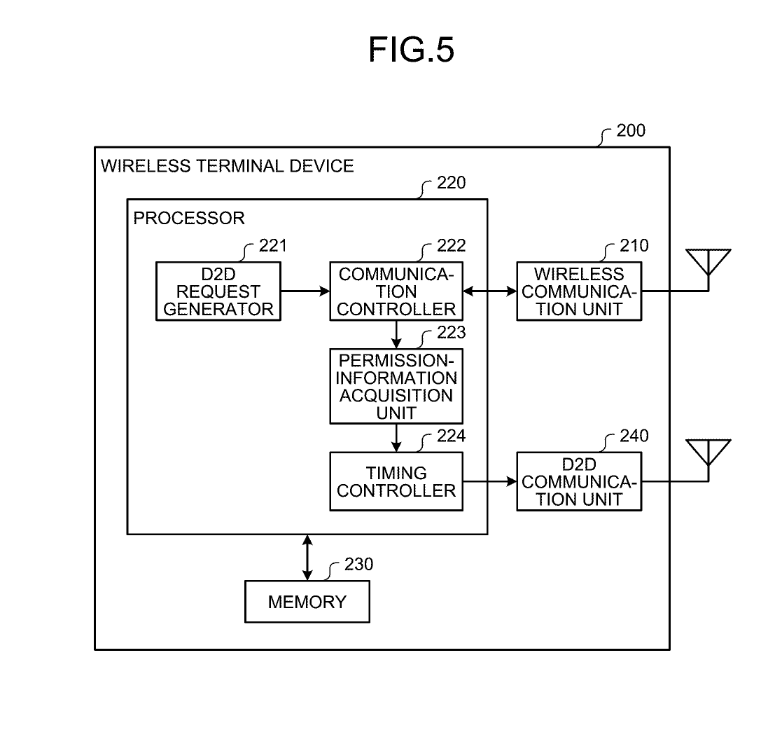

FIG. 4 is a diagram illustrating a specific example of a frame structure. As illustrated in FIG. 4, where a subframe 301 is a subframe allocated to downlink (D) and a subframe 303 is a subframe allocated to uplink (U), a boundary subframe 302 is the special subframe. Downlink (D) is allocated to a beginning portion of the subframe 302; uplink (U) is allocated to an end portion of the subframe 302. The period between the beginning portion and the end portion of the subframe 302 is a guard period (GP), to which none of downlink and uplink is allocated. Put another way, in a TDD frame structure, a periodically-allocated special subframe contains a GP, which is the non-communication period of cellular communication.

As described above, the periodically-allocated special subframes individually contain a GP. The GP determiner 123 determines a GP, in which the wireless terminal device 200, which is the sender of the D2D request, is permitted to perform D2D communication, among GPs of the special subframes.

Referring to FIG. 2 again, the permission information generator 124 generates permission information indicating the GP determined by the GP determiner 123. More specifically, the permission information generator 124 generates permission information indicating the GP, in which the wireless terminal device 200 is permitted to perform the D2D communication. The permission information generator 124 may cause other information, such as information about a frequency band to be used in the D2D communication, transmission power, and security to be contained in the permission information. The permission information generator 124 transmits the generated permission information to the wireless terminal device 200 via the wireless communication unit 140.

The memory 130, which may include, for instance, a Random Access Memory (RAM) or a Read Only Memory (ROM), stores various information for processing performed by the processor 120. The memory 130 temporarily stores information about subframe allocation of cellular communication, for instance.

The wireless communication unit 140 applies wireless transmission processing, e.g., Digital-to-Analog (D/A) conversion and up-conversion, to a transmission signal output from the communication controller 121 and transmits the processed signal via an antenna. Additionally, the wireless communication unit 140 applies wireless reception processing, e.g., Analog-to-Digital (A/D) conversion and down-conversion, to a received signal received via the antenna and outputs the processed signal to the communication controller 121. Furthermore, the wireless communication unit 140 applies wireless transmission processing to the permission information generated by the permission information generator 124 and transmits the processed permission information via the antenna. In the wireless communication system using TDD, the wireless communication unit 140 transmits signals in subframes allocated to downlink and receives signals in subframes allocated to uplink.

FIG. 5 is a block diagram illustrating a configuration of the wireless terminal device 200 according to the embodiment. The wireless terminal device 200 illustrated in FIG. 5 includes a wireless communication unit 210, a processor 220, a memory 230, and a D2D communication unit 240.

The wireless communication unit 210 wirelessly communicates with the base station 100 by cellular communication. More specifically, the wireless communication unit 210 receives a signal transmitted from the base station 100, applies wireless reception processing, e.g., down-conversion and A/D conversion, to the received signal, and outputs the processed signal to the processor 220. Additionally, the wireless communication unit 210 applies wireless transmission processing, e.g., D/A conversion and up-conversion, to a signal fed from the processor 220 and transmits the processed signal via an antenna. In the wireless communication system using TDD, the wireless communication unit 210 transmits signals in subframes allocated to uplink and receives signals in subframes allocated to downlink.

The processor 220, which may include, for instance, a CPU, an FPGA, or a DSP, centrally controls the entire wireless terminal device 200. More specifically, the processor 220 includes a D2D request generator 221, a communication controller 222, a permission-information acquisition unit 223, and a timing controller 224.

The D2D request generator 221 generates a D2D request requesting to start D2D communication in response to, for example, a user's operation or an instruction from application software requesting to start D2D communication. The D2D request generator 221 outputs the generated D2D request to the communication controller 222.

The communication controller 222 controls cellular communication between the wireless communication device 200 and the base station 100. More specifically, the communication controller 222 generates a transmission signal by encoding and modulating transmission data destined for the base station 100 and outputs the transmission signal to the wireless communication unit 210. The transmission data includes, for instance, the D2D request generated by the D2D request generator 221. Additionally, the communication controller 222 acquires received data by demodulating and decoding a received signal received by the wireless communication unit 210. The received data includes, for instance, the permission information transmitted from the base station 100.

The permission-information acquisition unit 223 acquires the permission information transmitted from the base station 100. As described above, the base station 100 transmits, by cellular communication, the permission information indicating the GP, in which D2D communication is permitted, as a response to the D2D request. Hence, the permission-information acquisition unit 223 acquires the permission information from the received data received by cellular communication.

The timing controller 224 controls timing of the D2D communication in accordance with the permission information acquired by the permission-information acquisition unit 223. More specifically, the timing controller 224 locates positions of special subframes each containing a GP from subframe allocation of cellular communication. The timing controller 224 instructs the D2D communication unit 240 to perform the D2D communication simultaneously when the GP, which is one of the position-located GPs contained in the special subframes and in which the D2D communication is permitted by the permission information, starts. More specifically, because the permission information indicates, among the GPs contained in the periodically-allocated special subframes, the GP in which the wireless terminal device 200 is permitted to perform the D2D communication, the timing controller 224 performs control such that the D2D communication is performed in the GP indicated by the permission information.

The memory 230, which may include, for instance, a RAM or a ROM, stores various information for processing performed by the processor 220. The memory 230 temporarily stores information about subframe allocation of cellular communication, permission information, and other information, for instance.

The D2D communication unit 240 performs the D2D communication under instruction from the timing controller 224. More specifically, the D2D communication unit 240 performs the D2D communication that does not traverse the base station 100 in the GP permitted by the permission information. None of the wireless terminal devices 200 performs cellular communication in the GP, and therefore the D2D communication does not interfere with cellular communication in the GP.

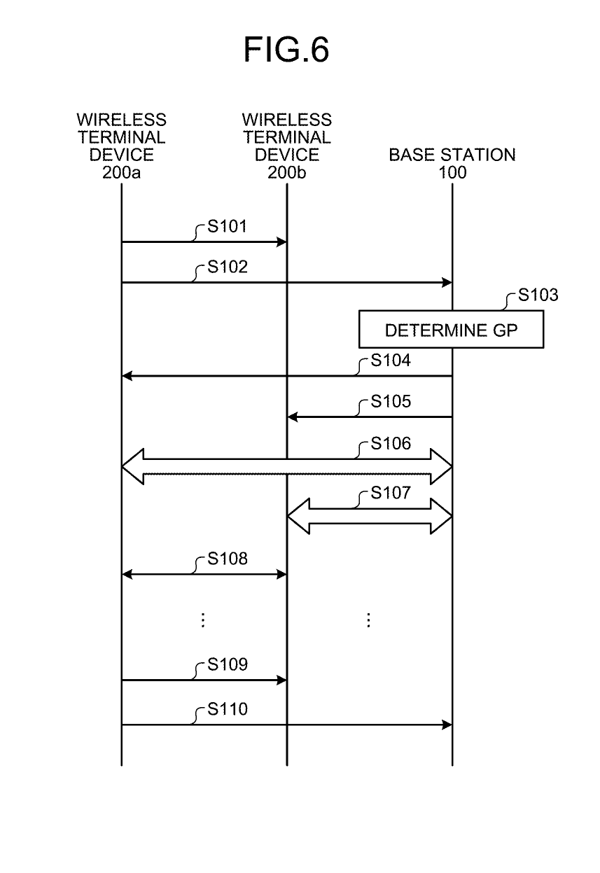

A wireless communication method performed in the wireless communication system configured as described above is described below with reference to the sequence diagram illustrated in FIG. 6. FIG. 6 is a sequence diagram illustrating a wireless communication method in a scenario where the wireless terminal device 200a requests to perform D2D communication with the wireless terminal device 200b.

When the wireless terminal device 200a requests to start D2D communication with the wireless terminal device 200b, the D2D request generator 221 of the wireless terminal device 200a generates a D2D request. The D2D request is transmitted to the wireless terminal device 200b and to the base station 100 by cellular communication (S101 and S102). Referring to FIG. 6, the D2D request is transmitted from the wireless terminal device 200a to the wireless terminal device 200b (S101); this D2D request is transmitted by cellular communication traversing the base station 100.

After being transmitted to the base station 100, the D2D request is acquired by the D2D-request acquisition unit 122 of the base station 100. The GP determiner 123 determines a GP, in which D2D communication is permitted (S103). The GP, in which the D2D communication is permitted, may be determined in further view of, for instance, whether there is another wireless terminal device that performs D2D communication or the amount of data to be transmitted by the D2D communication.

When the GP, in which D2D communication is permitted, has been determined, the permission information generator 124 generates permission information. The permission information is transmitted to the wireless terminal device 200a, which is the sender of the D2D request (S104). The permission information is also transmitted to the wireless terminal device 200b, with which the D2D communication is to be performed (S105). Note that the permission information is transmitted to the wireless terminal devices 200a and 200b by cellular communication.

When the permission information has been received by each of the wireless terminal devices 200a and 200b, the permission-information acquisition unit 223 of the wireless terminal device 200a, 200b acquires the permission information. The timing controller 224 causes processing to wait for timing of GP in which the D2D communication is permitted. During the above operations, the communication controller 222 and the wireless communication unit 210 of the wireless terminal device 200a, 200b perform cellular communication that traverses the base station 100 as usual (S106 and S107).

When the GP, in which the D2D communication is permitted, has started, the D2D communication units 240 of the wireless terminal devices 200a and 200b perform the D2D communication (S108). The D2D communication is performed over a duration of the permitted GP, but suspended when the GP has elapsed. When the permitted GP starts again, the suspended D2D communication is resumed. The above-described D2D communication enables a relatively small amount of communication without causing interference with cellular communication. Accordingly, multicast communication that, for instance, delivers advertisement information from a store or the like to a large number of unspecified wireless terminal devices or transmits control information from a master wireless terminal device to a plurality of servant wireless terminal devices can be performed efficiently.

Thereafter, the wireless terminal device 200a, 200b performs cellular communication; and the wireless terminal devices 200a and 200b perform D2D communication in the GP, in which D2D communication is permitted. When the D2D communication is to be completed, the wireless terminal device 200a transmits a notification of completion of the D2D communication to the wireless terminal device 200b, with which the D2D communication is performed (S109). The completion notification may be transmitted by either the D2D communication or the cellular communication traversing the base station 100. The wireless terminal device 200a transmits the notification of completion of the D2D communication also to the base station 100 (S110). This transmission allows the base station 100 to allocate the GP to D2D communication performed by another wireless terminal device after receiving the completion notification.

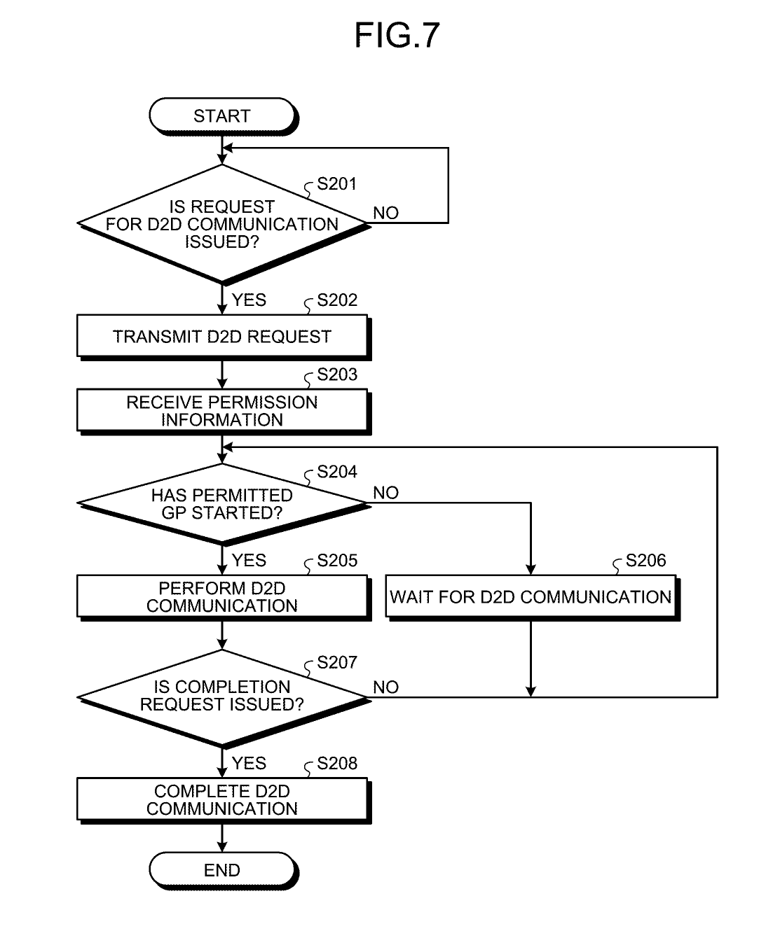

A communication control method performed by the wireless terminal device 200 to perform the D2D communication is described below with reference to the flowchart illustrated in FIG. 7.

The wireless terminal device 200 monitors whether starting D2D communication is requested by, for instance, a user's operation or an instruction from application software (Step S201). When a request for D2D communication is issued (Yes at S201), the D2D request generator 221 generates a D2D request requesting to start D2D communication. The D2D request is transmitted to the base station 100 via the wireless communication unit 210 by cellular communication (S202).

The transmitted D2D request is received by the base station 100, in which the GP determiner 123 determines a GP, in which D2D communication is permitted. Permission information containing information about the determined GP is transmitted from the base station 100 to the wireless terminal device 200 by cellular communication. The permission information transmitted from the base station 100 is received by the wireless communication unit 210 (S203) and acquired by the permission-information acquisition unit 223. The permission information is output to the timing controller 224. The timing controller 224 controls timing of the D2D communication.

More specifically, the timing controller 224 locates positions of GPs of special subframes using information about subframe allocation of cellular communication using TDD. Determination as to whether a GP, which is one of the position-located GPs and in which the D2D communication is permitted by the permission information, has started is made (S204). When the determination yields a result that the permitted GP has not started yet (No at S204), processing waits for start of the D2D communication (S206). Hence, even when a GP has started, if the GP is not the GP in which the D2D communication is permitted, the D2D communication is not started and thus the D2D communication unit 240 does not operate.

On the other hand, when the GP, in which the D2D communication is permitted by the permission information, has started (Yes at S204), the D2D communication unit 240 performs the D2D communication under instruction from the timing controller 224 (S205). More specifically, over the duration of the GP, the D2D communication unit 240 directly communicates wirelessly with the wireless terminal device, with which the communication is to be performed, without traversing the base station 100. A frequency band, transmission power, or a like parameter to be used in the D2D communication may be designated by the permission information.

When the D2D communication using the GP starts, the wireless terminal device 200 monitors whether a request to complete the D2D communication is issued (S207). During a period when a request to complete the D2D communication is not issued (No at S207), the D2D communication unit 240 continues the D2D communication under instruction from the timing controller 224. More specifically, when the D2D communication is permitted in a plurality of GPs by the permission information, the D2D communication is repeatedly performed in the plurality of GPs that occurs periodically.

When completing the D2D communication is requested by, for instance, a user's operation or an instruction from application software (Yes at S207), a notification of completion of the D2D communication is transmitted to the wireless terminal device, with which the communication is performed, either by the D2D communication unit 240 by the D2D communication or by the wireless communication unit 210 by cellular communication. Simultaneously, the wireless communication unit 210 sends the notification of completion of the D2D communication to the base station 100 by cellular communication. Hence, the D2D communication performed by the wireless terminal device 200 ends (S208).

As described above, according to the present embodiment, a base station determines a GP, in which a wireless communication terminal is permitted to perform D2D communication; the wireless communication terminal performs D2D communication with another wireless communication terminal using the permitted GP. Hence, the D2D communication is performed in the duration of the GP in which no uplink or downlink cellular communication signal is transmitted, which leads to reduction in interference with the cellular communication by the D2D communication. Furthermore, interference between different D2D communication sessions can be reduced by virtue of allocating GPs respectively to wireless terminal devices.

According to an aspect of an embodiment, a wireless communication device and a communication control method can advantageously reduce interference caused by D2D communication.

All examples and conditional language recited herein are intended for pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although the embodiment of the present invention has been described in detail, it should be understood that the various changes, substitutions, and alterations could be made hereto without departing from the spirit and scope of the invention.

What is claimed is:

1. A wireless communication device comprising:
a receiver that receives permission information indicating a period, in which device-to-device communication not traversing a base station is permitted, the period being one of non-communication periods imposed by cellular communication traversing the base station;
a determination unit that determines whether the period, in which the device-to-device communication is permitted, has started based on the permission information received by the receiver; and
a device-to-device communication unit that performs the device-to-device communication when the determination unit determines that the period, in which the device-to-device communication is permitted, has started.

2. The wireless communication device according to claim 1, further comprising
a transmitter that transmits request information requesting to start the device-to-device communication, wherein
the receiver receives the permission information as a response to the request information transmitted by the transmitter.

3. The wireless communication device according to claim 2, wherein the transmitter transmits the request information to the base station by the cellular communication.

4. The wireless communication device according to claim 1, wherein
the receiver receives the permission information including information about a frequency band to be used in the device-to-device communication, and
the device-to-device communication unit performs the device-to-device communication using the frequency band designated by the permission information received by the receiver.

5. A wireless communication device comprising:
a receiver that receives request information requesting to start device-to-device communication, the device-to-device communication being direct wireless communication performed by other wireless communication devices without traversing the wireless communication device;
a determination unit that determines a period, in which the device-to-device communication is permitted, the period being one of non-communication periods imposed by cellular communication traversing the wireless communication device, in accordance with the request information received by the receiver; and
a transmitter that transmits permission information indicating the period determined by the determination unit.

6. A communication control method comprising:
receiving permission information indicating a period, in which device-to-device communication not traversing a base station is permitted, the period being one of non-communication periods imposed by cellular communication traversing the base station;
determining whether the period, in which the device-to-device communication is permitted, has started based on the received permission information; and
performing the device-to-device communication when it is determined that the period, in which the device-to-device communication is permitted, has started.
